(19) United States
(12) Patent Application Publication
(10) Pub. No.: US 2012/0117857 A1
(43) Pub. Date: May 17, 2012

(54) HEAT-SHRINKABLE PROTECTION BARRIERE

(75) Inventors: Olivier FAHY, Lembras (FR); Daouia KENNOUCHE, Lyon (FR)

(73) Assignee: BERKEM DEVELOPPEMENT, Paris (FR)

(21) Appl. No.: 13/298,427

(22) Filed: Nov. 17, 2011

(30) Foreign Application Priority Data
Nov. 17, 2010 (FR) 10 59432

(51) Int. Cl. A01M 1/20; A01G 1/00; B32B 38/04; B29C 55/02; B32B 37/06

(52) U.S. Cl. 43/131; 264/291; 156/86; 47/32.7

(57) ABSTRACT

A protection barrier for a half-buried or buried object includes a sheet of longitudinal plastic material, the transversal dimension of which is unstable upon heating, the sheet including at least one root-repellent agent and/or insecticide agent so as to form a material barrier against roots and/or insects either living or moving in the ground.

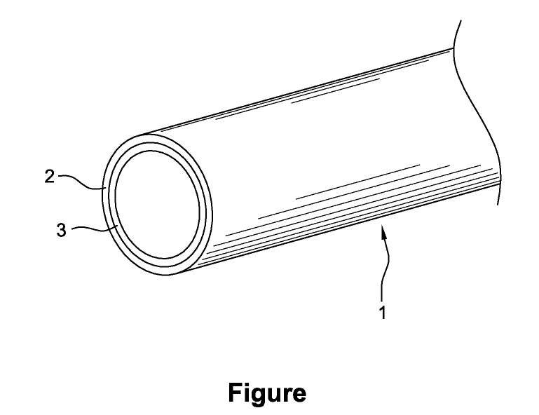

This invention relates to a heat-shrinkable protection barrier to protect half-buried or buried objects against roots and insects either living or moving in the ground. It also relates to a heat-shrinkable tubular envelope formed from such a protection barrier.

It is known that the underground ducts used in both construction and industry in addition to for producing, transporting and distributing water and energy suffer from biological degradation which, over time, is capable of modifying or destroying their functionality.

Underground ducts include both the water supply ducts and water discharge ducts of a building or facility and the piping intended for passing electric, pneumatic or optical cables in addition to drains intended to collect and remove underground water.

These ducts buried in the ground or the seals with which they are fitted are seen to become colonised in the long-term by plant roots and various invertebrates living or moving in the ground.

Numerous examples exist of drains obstructed by roots which require heavy, expensive replacement operations.

Furthermore, termites frequently cause degradation to water circulation or supply ducts in order to obtain the liquid required for their survival.

However, the bulk treatment of these ducts is not always possible for physical or chemical reasons.

Similarly, treatment by the incorporation of biocide substances into the bulk of the materials making up ducts used for drinking water is forbidden, for evident toxicity reasons.

The purpose of this invention is therefore to propose a material protection barrier positioned between the ground and the element being protected, being simple and economic, easy to implement and preventing or minimising damage caused by roots and termites or other insects.

This invention also relates to a protection barrier fitting tightly around the entire element being protected while remaining easy to position around this element.

The invention therefore relates to a flexible protection barrier for a half-buried or buried object.

According to the invention, this protection barrier comprises a sheet of longitudinal plastic material, the transversal dimension of which is unstable upon heating, this sheet comprising at least one root-repellent agent and/or insecticide agent so as to form a material barrier against roots and/or insects either living or moving in the ground.

Preferably, this sheet comprises both a root-repellent agent and an insecticide agent so as to efficiently protect the buried or half buried object.

“A sheet of longitudinal plastic material” refers to a film or a sheet in the form of a film.

In the different specific embodiments of this protection barrier, each having its specific advantages and capable of numerous possible technical combinations:
this barrier is made from a single piece,
   “Barrier is made from a single piece” means that this protection barrier is in one piece and therefore does not result from the assembly of originally separate elements.
the barrier has a single-layer or multilayer structure,
with this barrier having a multilayer structure, it includes an outer layer comprising a root-repellent agent and an inner layer comprising an insecticide agent,
at least the outer layer is formed from one or several heat-shrinkable polymers or from a mixture of one or several heat-shrinkable polymers and one or several non-heat-shrinkable polymers,
   Preferably, the outer and inner layers have a transversal dimension that is unstable upon heating.
   Advantageously, said at least one outer layer comprises 10% to 50% by weight of at least one heat-shrinkable polymer and 90% to 50% by weight of at least one non-heat-shrinkable polymer.
   Therefore, once the film has shrunk or the tubular envelope has been formed by assembling the lateral edges of this film, said at least one outer layer will have the same mechanical properties (tearing strength and/or impact strength, elasticity module, ultimate elongation, etc.) as a film containing a non-heat-shrinkable polymer only. For this heat-shrinkable film, preservation of the mechanical properties known for non-heat-shrinkable films ensures its compliance with the ten-year warranty criteria in the building and construction industry.
   For illustration purposes only, the heat-shrinkable polymer(s) shall be chosen from the group comprising an ethylene-alkyl (meth)acrylate copolymer, an ethylene and saturated carboxylic acid vinyl ester copolymer, an ethylene-vinyl acetate copolymer, a polyvinylidene chloride (PVDC), a fluoropolymer such as a fluorinated (ethylene-propylene) polymer or perfluoroalkoxy (PFA).
   Preferably, the outer layer also comprises at least one ultraviolet (UV) absorber. Advantageously, the outer layer has a water vapour permeability of less than or equal to 1.5 g/m²/day.1013.25 hPa, as water vapour permeability is measured under a pressure of 1013.25 hPa over a surface area of 1 m² for 24 hours at 25° C. and at a relative humidity of 60%.
   For illustration purposes only, the non-heat-shrinkable polymer(s) of the outer layer shall therefore be chosen from the group comprising polyethylene, polypropylene, the ethylene and vinyl acetate cross-linked copolymer, the ethylene-vinyl alcohol copolymer and polybutylene.
moreover, this outer layer has an oxygen permeability of less than 5000 cm³/m²/day.1013.25 hPa, as oxygen permeability is measured under a pressure of 1013.25 hPa over a surface area of 1 m² for 24 hours at 25° C. and at a relative humidity of 60%,
   One example of a polyolefin-based polymer with both a permeability of less than the aforementioned water vapour permeability and a permeability of less than the aforementioned oxygen permeability is polyethylene.
   In a more general manner, the inner layer loaded with an anti-termite insecticide is strengthened by treating the surface of its active side coming into contact with the ground by using an outer polymer layer forming a sealed barrier against the pH conditions of the surrounding environment capable of degrading the insecticide's active ingredient.

Alternatively, this barrier also comprises an intermediate layer, this intermediate layer having an oxygen permeability of less than 5000 cm³/m²/day.1013.25 hPa, as oxygen permeability is measured under a pressure of 1013.25 hPa over a surface area of 1 m² for 24 hours at 25° C. and at a relative humidity of 60%,

One example of a polyolefin-based polymer with a permeability of less than the aforementioned oxygen permeability is polyethylene.
this outer layer has a thickness of between 10 and 150 μm, or even better of between 50 and 100 μm, so as to limit the surface area of the outer layer subject to degradation caused by insects before their contact with the insecticide agent of said inner layer,
the inner and outer layers are obtained with different polyolefin-based resins,
with this barrier having a single layer structure, it comprises a mixture of one or several non-heat-shrinkable polyolefins and one or several heat-shrinkable polymers, and at least one root-repellent agent and one insecticide agent,
   The non-heat-shrinkable polyolefin(s) can be chosen from the group comprising polyethylene (PE), polypropylene (PP), an ethylene-propylene copolymer (EPR), polybutylene (PB), polymethylpentene (PMP), ethylene-vinyl acetate (EVA) and polyamide (PA).
   For illustration purposes only, the heat-shrinkable polymer(s) shall be chosen from the group comprising an ethylene-alkyl (meth)acrylate copolymer, an ethylene and saturated carboxylic acid vinyl ester copolymer, an ethylene-vinyl acetate copolymer, a polyvinylidene chloride (PVDC), a fluoropolymer such as a fluorinated (ethylene-propylene) polymer (FEP) or perfluoroalkoxy (PFA).
   If the heat-shrinkable polymer is an ethylene-alkyl (meth)acrylate copolymer, the alkyls can have up to 24 carbon atoms. Examples of alkyl methacrylate or acrylate in particular include methyl methacrylate, ethyl acrylate, n-butyl acrylate, isobutyl acrylate and 2-ethylhexyl acrylate.
   If the heat-shrinkable polymer is an ethylene and saturated carboxylic acid vinyl ester copolymer, the ester can be vinyl acetate, vinyl propionate or vinyl butyrate.
   Advantageously, in ethylene and (meth)acrylate or vinyl ester copolymers, the comonomer content is between 4 and 30% by weight for improved shrinking of the protection barrier
   Preferably, this single-layer structure also comprises at least one ultraviolet (UV) absorber.
this sheet includes at least one additive chosen from the group comprising a slip additive, an antistatic agent, an antiblocking agent, a colorant, a pigment and combinations of these elements,
the root-repellent agent is a chlorophenoxy derivative,
   For example, this root-repellent agent is 2-(2-methyl-4-chlorophenoxy) propionic acid, also known as MCPP acid.
   It should be noted that this root-repellent agent is a chemical substance with non-pesticide and non-biocide properties. The root-repellent agent has no mortal effect with regard to roots and trees/plants.
   The root-repellent effect is a contact effect. After contact with the barrier, the root tips lignify, i.e. growth of these roots is firstly slowed and then stopped. Under no circumstances does the tree or plant die, as the other roots, via a memory effect, extend in more favourable areas. The preservation of the plant or tree is therefore advantageously guaranteed.
   The root-repellent agent is therefore a root-repellent agent using the contact effect.
said insecticide is chosen from the family of pyrethroids, neonicotinoids or carbamates.
   For illustration purposes only, this insecticide can be chosen from the group comprising bifenthrin, alpha-cypermethrin, cypermethrin and permethrin.

The invention also relates to a heat-shrinkable sheath to protect a duct or pipeline. According to the invention, this sheath is comprised of a protection barrier as previously described.

This heat-shrinkable sheath is thus formed by assembling the lateral edges of the longitudinal sheet.

This sheath is particularly adapted to fit tightly around ducts or bunches of electric cable ducts intended to be buried to ensure their protection.

As this sheath is an add-on, it can advantageously be implemented to protect ducts transporting drinking water without presenting any harmful effects for the end user.

Advantageously, if the duct being protected acts as a drain, this sheath contains micro perforations enabling the drainage of liquids.

This invention also relates to a method for manufacturing a heat-shrinkable protection barrier as previously described.

According to the invention, the following steps are performed:
a) at least one root-repellent agent and/or insecticide agent is introduced and distributed in a homogenous manner within a base plastic material,
b) from the composition thus obtained and melted, a film is manufactured, which is transversely stretched while being heated over the crystalline melting point of the base plastic material, this melting point being below the decomposition temperature of said root-repellent agent and/or said insecticide agent so as not to destabilise said agent(s),
c) said film thus obtained is then cooled.

Preferably, before cooling said sheet, the latter is positioned into a tube or substantially tubular shape. A heat-shrinkable tube or tubular envelope is thus created.

Advantageously, in step a), said at least one root-repellent agent and/or insecticide agent is introduced into said base plastic material at a temperature of between 150° C. and 200° C., and more precisely of between 170° C. and 200° C. for a LDPE.

Preferably, 10% to 50% by weight of at least one heat-shrinkable polymer is mixed with 90% to 50% by weight of a non-heat-shrinkable polymer to form said base plastic material.

The non-heat-shrinkable polyolefin(s) can be chosen from the group comprising polyethylene (PE), polypropylene (PP), an ethylene-propylene copolymer (EPR), polybutylene (PB), polymethylpentene (PMP), ethylene-vinyl acetate (EVA) and polyamide (PA).
For illustration purposes only, the heat-shrinkable polymer(s) shall be chosen from the group comprising an ethylene-alkyl (meth)acrylate copolymer, an ethylene and saturated carboxylic acid vinyl ester copolymer, an ethylene-vinyl acetate copolymer, a polyvinylidene chloride (PVDC), a fluoropolymer such as a fluorinated (ethylene-propylene) polymer (FEP) or perfluoroalkoxy (PFA).
Advantageously, at least one slip additive can be incorporated into the melted composition, prior to preparing the sheet by extrusion. This slip additive is incorporated so as to be present in the most outer layers of the sheet. Such a slip additive can, for example, be chosen from fatty acid amides such as erucamide and can be introduced at the rate of 200 to 5,000 ppm.
Generally, such a slip additive is incorporated into the sheet if the latter is not to be stamped. This slip additive reduces friction resulting from contact between the heat-shrinkable protection barrier and another surface made from plastic material or other material.
For illustration purposes only, this slip agent will ease the positioning of the heat shrinkable tubular envelope in relation to a duct or bunch of electric cable ducts being protected. It is known that by trying to slide a tube onto very large-scale cables, these cables become difficult to introduce into the opposite end of the tube.
At least one antiblocking agent can also be incorporated into the melted composition, prior to preparing the sheet by extrusion. This antiblocking agent is incorporated so as to be present in the most outer layers of the sheet. The purpose of this antiblocking agent is to reduce the sheet's tendency to stick to itself when wound into a reel, so as to ease its unwinding.
Such an antiblocking agent also comprises mineral filler particles such as silica. Prior to its use, the sheet can be given antistatic properties. These antistatic properties enable the sheet to maintain its flat position and slide on manufacturing machines, without the tendency to wind around itself, which would risk disrupting or even blocking the entire manufacturing process.
For example, antistatic properties can be given to the sheet by coating its outer layers with a solution made from an antistatic agent. Known antistatic agents include the alkylamine family.

Finally, the invention relates to the use of the tubular envelope formed from said protection barrier as previously described or obtained by the manufacturing method as previously described, to create a sealed junction between a protection film and a protection sleeve, said film and said sleeve being intended to form a material barrier for a buried or half-buried object against roots and/or insects living or moving in the ground.

According to the invention, the following steps are performed:
a) a cut is made into said protection film in order to pass said protection sleeve,
b) said sleeve is introduced through said cut, while ensuring that one overlap part of said protection film thus protruding from the rest of said protection film at least partially covers the edge of the part of said sleeve having passed through said cut,
c) said tubular envelope is introduced via the free end of said part of said sleeve having passed through said cut, and said tubular envelope is positioned so as to at least partially cover said overlap part and said sleeve,
d) said tubular envelope is heated so that it tightens around said overlap part of said protection film and said protection sleeve.

Naturally, the protection film and the protection sleeve each comprise at least one root-repellent agent and/or insecticide agent. A material barrier is thus obtained, forming a comprehensive shield against roots and/or termites, this barrier comprising a flat or substantially flat film and a sleeve forming a shaft, whose main axis is outside of the plane of this film, this shaft enabling, for example, the passage of electric cable ducts.

Preferably, after making a cross-shaped cut into said protection film in step a), step b) involves ensuring that all of the free sections of said film resulting from this cut and connected to said film surround the part of said sleeve having passed through said cut. These free sections thus form the overlap part of said protection film.

Advantageously, in step d), a homogenous temperature is applied to the entire tubular envelope to avoid the development of a local break point in said envelope.

“Homogeneous” means that this temperature applied to the surface of the tubular envelope does not vary by more than 20° C. over this entire surface area.

The invention will be described in more detail with reference to the single appended FIGURE, which schematically represents a heat-shrinkable protection envelope according to one preferred embodiment of the invention;

The single FIGURE shows a heat-shrinkable envelope or heat-shrinkable sheath for protecting 1 electric cable ducts according to one preferred embodiment of the invention.

This protection sheath 1, made from a single piece, can in particular be obtained by multilayer extrusion-blow moulding. This protection sheath 1 comprises an outer layer 2 and an inner layer 3.

The inner layer 3 is intended to be positioned on the side of the electric cable ducts being protected, whereas the outer layer 2 is intended to be in contact with the ground.

The outer layer 2 comprises a root-repellent agent and the inner layer 3 comprises an insecticide. Advantageously, the outer layer 2 protects the inner layer 3 containing anti-termite properties.

Indeed, over time, roots can develop in the immediate environment of the protection sheath 1. However, during their growth, these roots could pierce the layer containing the insecticide 3 if the latter was not protected by the outer layer 2 containing the root-repellent agent. This layer containing the insecticide with local or systemic action, is not phytotoxic. By travelling through the root network that they have taken over, termites could therefore easily breach a sheath fitted with an insecticide only, this sheath having already been penetrated by roots at multiple points.

Furthermore, the outer layer 2 advantageously forms a shield preventing the insecticide contained within the inner layer 3 from being transferred into the external environment surrounding the protection sheath 1. Similarly, the interposition of an outer layer 2 between the external environment surrounding the sheath and the inner layer 3 containing the anti-termite active ingredient, prevents the conditions surrounding the sheath from degrading the anti-termite active ingredient and thus making it ineffective. The properties of the anti-termite active ingredient are therefore preserved over time.

The root-repellent active ingredient of the outer layer 2 is, for example, 2-(2-methyl-4-chlorophenoxy) propionic acid (CAS No. 93-65-2) integrated into the bulk of the polymer making up the outer layer. 2-(2-methyl-4-chlorophenoxy) propionic acid (CAS No. 93-65-2) for example at doses varying from 0.10% to 2.00% (m/m) has a high root-repellent action. Alternatively, this root-repellent active ingredient can be a chlorophenoxy herbicide.

The outer layer 2 is obtained from a base plastic material comprising 20% by weight of heat-shrinkable polymer and 80% by weight of non-heat-shrinkable polymer. The non-heat-shrinkable polymer is a low density polyethylene (LDPE) whereas the heat-shrinkable polymer is an ethylene-vinyl acetate (EVA) copolymer. Advantageously, this copolymer contains 4% to 30% by weight of vinyl acetate.

Exposure of the heat-shrinkable envelope to a temperature of more than or equal to the softening temperature of the heat-shrinkable polymer causes the entire envelope structure to shrink, which therefore tightens around the electric cable ducts being protected. The heat source implemented to heat the envelope can be a paint burner or a blowpipe.

The temperature applied is always lower than the decomposition temperature of the root-repellent agent and insecticide agent to avoid destabilising these agents, which could make them ineffective.

This outer layer 2 also contains ultraviolet absorber active ingredients known by one of ordinary skill in the art, such as carbon black, salicylates, phenyl benzoates and benzophenones for example.

This outer layer 2 can represent 10 to 80% of the overall thickness of the protection sheath 1.

While exploring their environment, target insects come into contact with the outer layer 2, which does not repel them. While attempting to breach this layer, they erode the outer layer 2 and access a minute surface area of the inner layer 3, the insecticide content of which has not been reduced through contact with the external environment surrounding the envelope 1 and quickly generates a high mortality rate for the target insects. Breaks in the outer layer 2 caused by termites have a surface area too small to enable the external environment surrounding the envelope 1 to cause degradation to the insecticide.

The inner layer 3 has, for example, a thickness of between 10 μm and 300 μm. This inner layer 3 entering into contact with the electric cable ducts being protected constitutes the anti-termite barrier. It contains an insecticide from the pyrethroid family integrated at a very high dose into the bulk of the polymer making up the inner layer.

Bifenthrin (CAS No. 82657-04-3) at doses varying from 0.05% to 2.00% (m/m) in a low density polyethylene layer will suffice however is not exclusive. Alpha-cypermethrin, permethrin or cypermethrin associated with a polymer chosen from the group comprising low-density polyethylene, high-density polyethylene, polypropylene and ethylene-vinyl acetate will also suffice.

At the given doses, the insecticide is fast acting and lethal when in contact with termites, which prevents the latter from breaching the protection envelope 1. This inner layer 3 can represent 20 to 90% of the overall thickness of the protection envelope.

The total thickness of the material constituted from the two described layers can vary from 50 μm to 5 millimetres according to the nature and layout of the element being protected.

1. A protection barrier for a half-buried or buried object, characterised in that it comprises a sheet of longitudinal plastic material, the transversal dimension of which is unstable upon heating, said sheet comprising at least one root-repellent agent and/or insecticide agent so as to form a material barrier against roots and/or insects either living or moving in the ground.

2. A barrier according to claim 1, characterised in that it is made from a single piece.

3. A barrier according to claim 1, characterised in that it has a single-layer or multilayer structure.

4. A barrier according to claim 3 characterised in that, said barrier having a multilayer structure, it includes an outer layer (2) comprising a root-repellent agent and an inner layer (3) comprising an insecticide agent.

5. A barrier according to claim 4, characterised in that said outer layer (2) also comprises at least one ultraviolet absorber.

6. A barrier according to claim 4, characterised in that the outer layer (2) has a water vapour permeability of less than or equal to 1.5 g/m²/day.1013.25 hPa, as water vapour permeability is measured under a pressure of 1013.25 hPa over a surface area of 1 m² for 24 hours at 25° C. and at a relative humidity of 60%.

7. A barrier according to claim 4, characterised in that said outer layer also has an oxygen permeability of less than 5000 cm³/m²/day.1013.25 hPa, as oxygen permeability is measured under a pressure of 1013.25 hPa over a surface area of 1 m² for 24 hours at 25° C. and at a relative humidity of 60%.

8. A barrier according to claim 4, characterised in that said barrier also comprises an intermediate layer, said intermediate layer having an oxygen permeability of less than 5000 cm³/m²/day.1013.25 hPa, as oxygen permeability is measured under a pressure of 1013.25 hPa over a surface area of 1 m² for 24 hours at 25° C. and at a relative humidity of 60%.

9. A barrier according to claim 4, characterised in that at least said outer layer is formed from one or several heat-shrinkable polymers or from a mixture of one or several heat-shrinkable polymers and one or several non-heat-shrinkable polymers.

10. A barrier according to claim 4, characterised in that said outer layer has a thickness of between 10 and 150 μm, or even better of between 50 and 100 μm, so as to limit the surface area of the outer layer subject to degradation caused by insects before their contact with the insecticide agent of said inner layer.

11. A barrier according to claim 3 characterised in that, said barrier having a single layer structure, it comprises a mixture of one or several non-heat-shrinkable polyolefins and one or several heat-shrinkable polymers, and at least one root-repellent agent and one insecticide agent.

12. A barrier according to claim 11, characterised in that the non-heat-shrinkable polyolefin(s) are chosen from the group comprising polyethylene (PE), polypropylene (PP), an ethylene-propylene copolymer (EPR), polybutylene (PB), polymethylpentene (PMP), ethylene-vinyl acetate (EVA) and polyamide (PA).

13. A barrier according to claim 11, characterised in that it also comprises at least one ultraviolet absorber.

14. A barrier according to claim 9, characterised in that the heat-shrinkable polymer(s) are chosen from the group comprising an ethylene-alkyl (meth)acrylate copolymer, an ethylene and saturated carboxylic acid vinyl ester copolymer, an ethylene-vinyl acetate copolymer, a polyvinylidene chloride (PVDC), a fluoropolymer such as a fluorinated (ethylene-propylene) polymer (FEP) or perfluoroalkoxy (PFA).

15. A barrier according to claim 1, characterised in that said sheet includes at least one additive chosen from the group comprising a slip additive, an antistatic agent, an antiblocking agent, a colorant, a pigment and combinations of these elements,

16. A method for manufacturing a shrinkable protection barrier according to claim 1, characterised in that the following steps are performed:
a) at least one root-repellent agent and/or insecticide agent is introduced and distributed in a homogenous manner within a base plastic material,
b) from the composition thus obtained and melted, a film is manufactured, which is transversely stretched while being heated over the crystalline melting point of the base plastic material, this melting point being below the decomposition temperature of said root-repellent agent and/or said insecticide agent so as not to destabilise said agent(s),
c) said film thus obtained is then cooled.

17. A method according to claim 16 characterised in that, before cooling said sheet, the latter is positioned into a tube or substantially tubular shape.

18. A method according to claim 16 characterised in that in step a), said at least one root-repellent agent and/or insecticide agent is introduced into said base plastic material at a temperature of between 150° C. and 200° C.

19. A method according to claim 16, characterised in that 10% to 50% by weight of at least one heat-shrinkable polymer is mixed with 90% to 50% by weight of a non-heat-shrinkable polymer to form said base plastic material.

20. A method of using the tubular envelope formed from said protection barrier according to claim 1 to create a sealed junction between a protection film and a protection sleeve, said film and said sleeve being intended to form a material barrier for a buried or half-buried object against roots and/or insects living or moving in the ground, characterised in that the following steps are performed:
a) a cut is made into said protection film in order to pass said protection sleeve,
b) said sleeve is introduced through said cut, while ensuring that one overlap part of said protection film thus protruding from the rest of said protection film at least partially covers the edge of the part of said sleeve having passed through said cut,
c) said tubular envelope is introduced via the free end of said part of said sleeve having passed through said cut, and said tubular envelope is positioned so as to at least partially cover said overlap part and said sleeve,
d) said tubular envelope is heated so that it tightens around said overlap part of said protection film and said protection sleeve.

21. The method according to claim 20, characterised in that after making a cross-shaped cut into said protection film in step a), step b) involves ensuring that all of the free sections of said film resulting from this cut and connected to said film surround the part of said sleeve having passed through said cut.

22. The method according to claim 20 characterised in that, in step d), a homogenous temperature is applied to the entire tubular envelope to avoid the development of a local break point in said envelope.
